(19) United States
(12) Patent Application Publication
(10) Pub. No.: US 2005/0081686 A1
(43) Pub. Date: Apr. 21, 2005

(54) Adjustable spanner

(76) Inventor: Chih-Ching Hsien, Taichung (TW)

Correspondence Address: Chih-Ching Hsien, 58, MA YUAN WEST ST.,, TAICHUNG, TW

(21) Appl. No.: 10/689,929

(22) Filed: Oct. 17, 2003

(51) Int. Cl. B25B 13/16

(52) U.S. Cl. 81/170

(57) ABSTRACT

An adjustable spanner includes a main body having an end formed with a drive portion having a first side and a second side. The second side of the drive portion is formed with an inclined face inclined toward the first side of the drive portion. Thus, the adjustable spanner is provided with an inclined face, so that the adjustable spanner can be used to operate a screw member located adjacent to an obstruction or located at a deeper zone of a workpiece, thereby facilitating the user operating the adjustable spanner.

### BACKGROUND OF THE INVENTION

1. Field of the Invention

The present invention relates to an adjustable spanner, and more particularly to an adjustable spanner that can be operated conveniently.

2. Description of the Related Art

A conventional adjustable spanner comprises a main body having a first end formed with a drive portion and a second end formed with a handle portion. Thus, the user's one hand can hold the handle portion to rotate the drive portion so as to rotate a screw member on a workpiece.

However, the handle portion and the drive portion are located at the same plane, so that when the drive portion is rested on the screw member, the handle portion is also rested on the surface of the workpiece. Thus, the user's hand touches and rubs the surface of the workpiece successively, thereby greatly causing inconvenience to the user during operation. In addition, the conventional adjustable spanner cannot be used to operate a screw member located adjacent to an obstruction or located at a deeper zone of a workpiece, thereby limiting the versatility of the conventional adjustable spanner.

### SUMMARY OF THE INVENTION

The primary objective of the present invention is to provide an adjustable spanner that can be operated easily and conveniently.

Another objective of the present invention is to provide an adjustable spanner that can largely reduce the restriction of space to facilitate the user operating the adjustable spanner.

A further objective of the present invention is to provide an adjustable spanner, wherein the adjustable spanner is provided with an inclined face, so that the adjustable spanner can be used to operate a screw member located adjacent to an obstruction or located at a deeper zone of a workpiece, thereby facilitating the user operating the adjustable spanner.

In accordance with the present invention, there is provided an adjustable spanner, comprising a main body having an end formed with a drive portion formed with a fixed jaw and a slideway, an adjustment screw rotatably mounted in the main body, and a movable jaw movably mounted on the drive portion and having a bottom formed with a rack slidably mounted in the slideway of the drive portion and engaged with the adjustment screw, wherein:

the drive portion has a first side and a second side;

the second side of the drive portion is formed with an inclined face inclined toward the first side of the drive portion, so that an included angle is defined between the inclined face of the second side of the drive portion and the first side of the drive portion.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an adjustable spanner in accordance with the preferred embodiment of the present invention;

FIG. 2 is a partially cut-away plan view of the adjustable spanner as shown in FIG. 1;

FIG. 3 is a side plan view of the adjustable spanner as shown in FIG. 1;

FIG. 4 is a side plan view of the adjustable spanner as shown in FIG. 1;

FIG. 5 is a side plan view of an adjustable spanner in accordance with another embodiment of the present invention;

FIG. 6 is a side plan view of the adjustable spanner in accordance with another embodiment of the present invention;

FIG. 7 is a schematic plan operational view of the adjustable spanner as shown in FIG. 1 in use;

FIG. 8 is a schematic plan operational view of the adjustable spanner as shown in FIG. 1 in use; and

FIG. 9 is a schematic plan operational view of the adjustable spanner as shown in FIG. 1 in use.

### DETAILED DESCRIPTION OF THE INVENTION

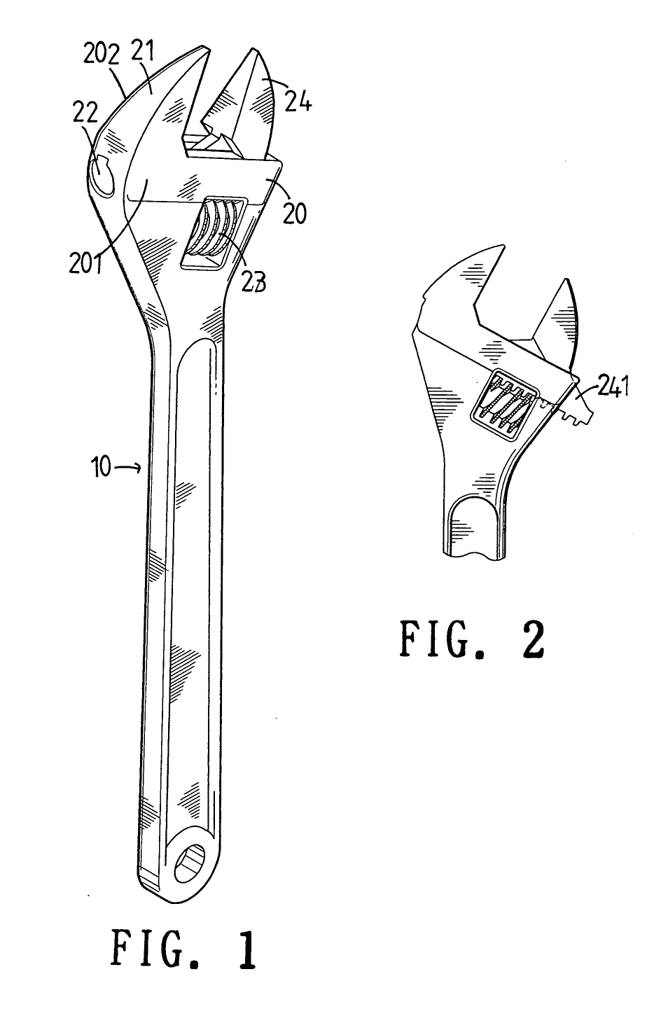

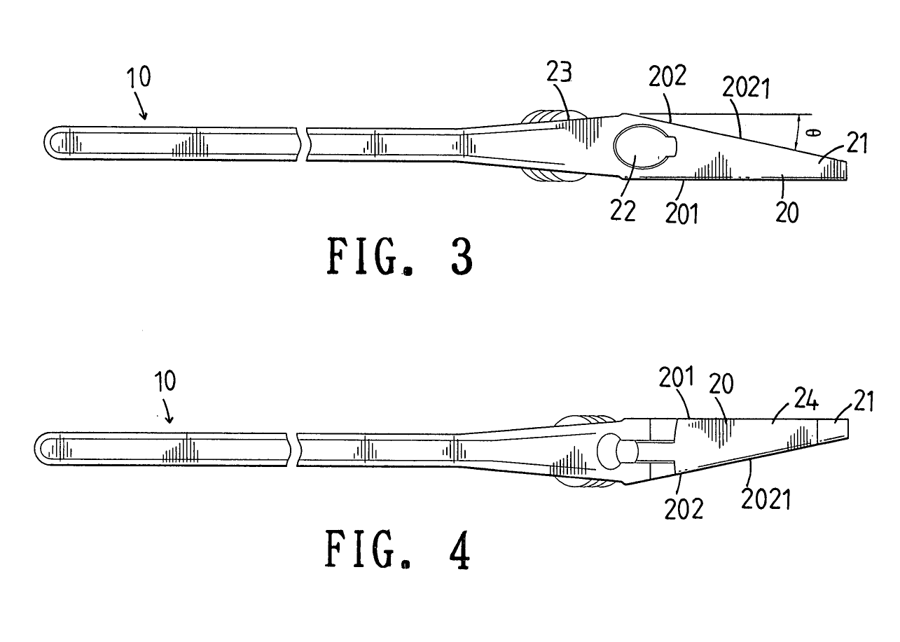

Referring to the drawings and initially to FIGS. 1-4, an adjustable spanner in accordance with the preferred embodiment of the present invention comprises a main body 10 having an end formed with a drive portion 20 formed with a fixed jaw 21 and a slideway 22, an adjustment screw 23 rotatably mounted in the main body 10, and a movable jaw 24 movably mounted on the drive portion 20 and having a bottom formed with a rack 241 slidably mounted in the slideway 22 of the drive portion 20 and engaged with the adjustment screw 23. Thus, the rack 241 is moved by rotation of the adjustment screw 23, so that the movable jaw 24 is moved relative to the fixed jaw 21.

The drive portion 20 has a first side 201 and a second side 202. The first side 201 of the drive portion 20 is in parallel with the main body 10. The second side 202 of the drive portion 20 is formed with an inclined face 2021 inclined toward the first side 201 of the drive portion 20, so that an included angle θ is defined between the inclined face 2021 of the second side 202 of the drive portion 20 and the first side 201 of the drive portion 20. Preferably, the included angle θ between the inclined face 2021 of the second side 202 of the drive portion 20 and the first side 201 of the drive portion 20 is about 10 to 20 degrees.

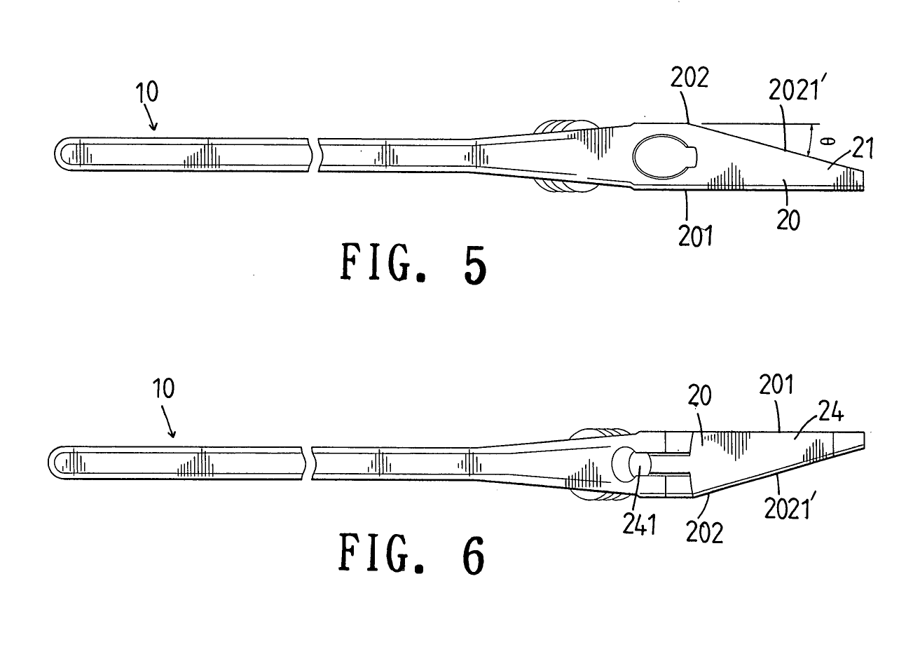

As shown in FIGS. 3 and 4, the inclined face 2021 of the second side 202 of the drive portion 20 is extended upward from a horizontal extension of a bottom of an included angle of the fixed jaw 21, so that the second side 202 of the drive portion 20 is inclined relative to the first side 201 of the drive portion 20.

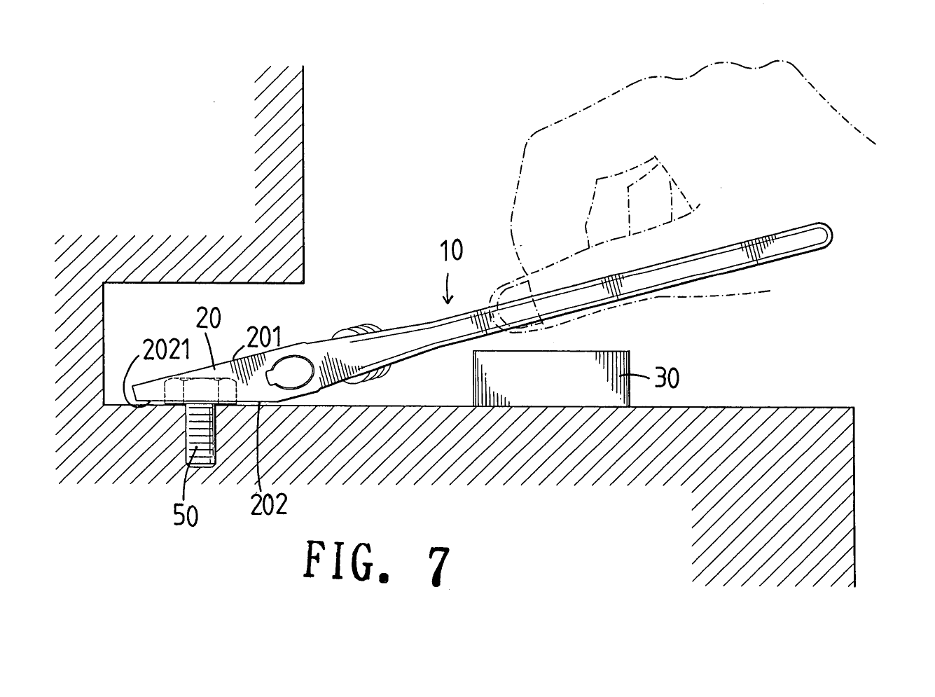

Referring to FIGS. 5 and 6, an adjustable spanner in accordance with another embodiment of the present invention is shown, wherein the inclined face 2021′ of the second side 202 of the drive portion 20 is extended upward from a horizontal extension of a bottom of the rack 241, so that the second side 202 of the drive portion 20 is inclined relative to the first side 201 of the drive portion 20.

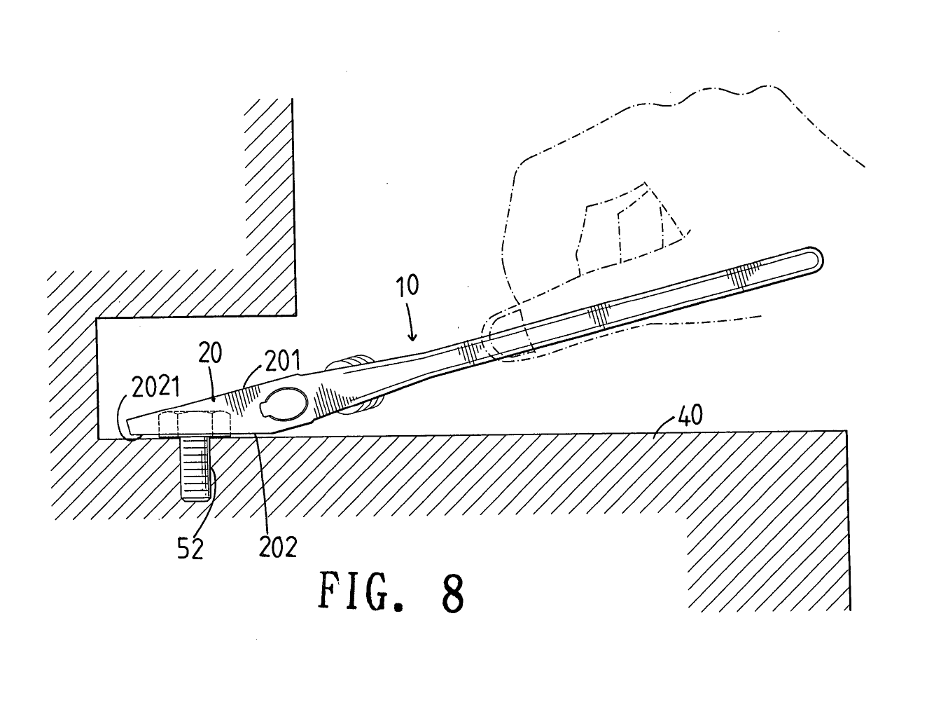

Referring to FIG. 7, the adjustable spanner is used to operate a screw member 50 located adjacent to a workpiece 30. At this time, the inclined face 2021 of the second side 202 of the drive portion 20 is rested on the screw member 50, while the main body 10 is disposed at an inclined state and is spaced from the workpiece 30, so that the adjustable spanner is used to operate the screw member 50 easily and conveniently.

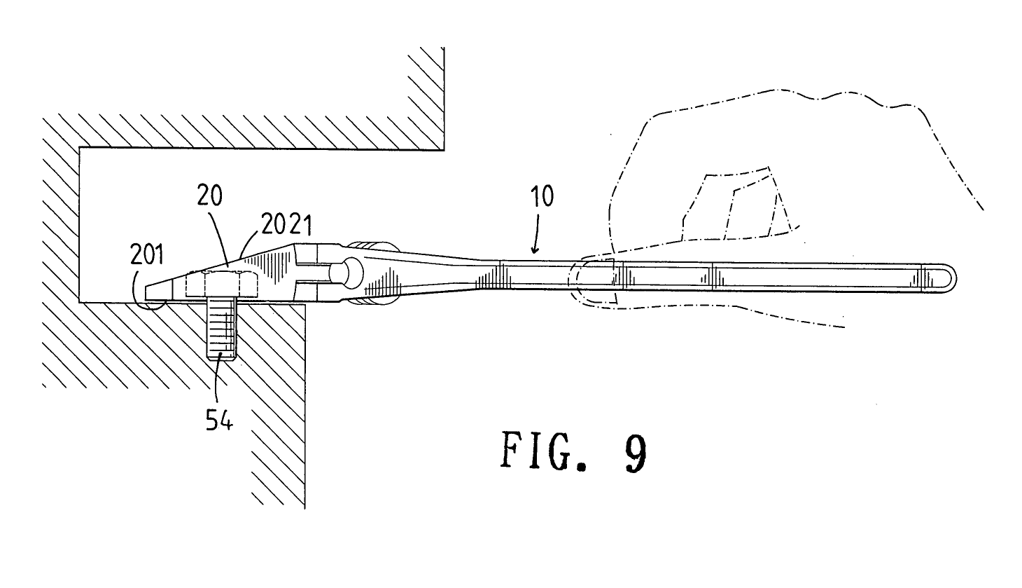

Referring to FIG. 8, the adjustable spanner is used to operate a screw member 52 located at a deeper zone of a workpiece 40. At this time, the inclined face 2021 of the second side 202 of the drive portion 20 is rested on the screw member 52, while the main body 10 is disposed at an inclined state and is spaced from the workpiece 40, so that the adjustable spanner is used to operate the screw member 52 easily and conveniently.

Referring to FIG. 9, the adjustable spanner is used to operate a screw member 54 without any obstruction. At this time, the first side 201 of the drive portion 20 is rested on the screw member 54, while the main body 10 is disposed at a horizontal state, so that the adjustable spanner is used to operate the screw member 54 easily and conveniently.

Accordingly, the adjustable spanner is provided with an inclined face 2021, so that the adjustable spanner can be used to operate a screw member located adjacent to an obstruction or located at a deeper zone of a workpiece, thereby facilitating the user operating the adjustable spanner.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1-7. (canceled)

8. An adjustable spanner, comprising a main body having an end formed with a drive portion formed with a fixed jaw and a slideway, an adjustment screw rotatably mounted in a main body, and a movable jaw movably mounted on the drive portion and having a bottom formed with a rack slidably mounted in the slideway of the drive portion and engaged with the adjustment screw; another end of the adjustable spanner being a handle with two parallel sides and one round end; wherein
the drive portion has a first side and a second side;
the second side of the drive portion is formed with an inclined face inclined toward the first side of the drive portion, so that an included angle is defined between the inclined face of the second side of the drive portion and the first side of the drive portion;
wherein the first side of the drive portion is in parallel with the main body;
wherein the included angle between the inclined face of the second side of the drive portion and the first side of the drive portion is about 10 to 20 degrees; and
wherein the inclined face of the second side of the drive portion is extended upward from a horizontal extension of a bottom of an inclined angle of the fixed jaw, so that the second side of the drive portion is inclined relative to the first side of the drive portion.

9. An adjustable spanner, comprising a main body having an end formed with a drive portion formed with a fixed jaw and a slideway, an adjustment screw rotatably mounted in a main body, and a movable jaw movably mounted on the drive portion and having a bottom formed with a rack slidably mounted in the slideway of the drive portion and engaged with the adjustment screw; another end of the adjustable spanner being a handle with two parallel sides and one round end; wherein
the drive portion has a first side and a second side;
the second side of the drive portion is formed with an inclined face inclined toward the first side of the drive portion, so that an included angle is defined between the inclined face of the second side of the drive portion and the first side of the drive portion;
wherein the first side of the drive portion is in parallel with the main body;
wherein the included angle between the inclined face of the second side of the drive portion and the first side of the drive portion is about 10 to 20 degrees;
wherein the inclined face of the second side of the drive portion is extended upward from a horizontal extension of a bottom of an inclined angle of the fixed jaw, so that the second side of the drive portion is inclined relative to the first side of the drive portion; and
wherein the inclined face of the second side of the drive portion is extended upward from a horizontal extension of a bottom of the rack, so that the second side of the drive portion is inclined relative to the first side of the drive portion.
